(19) United States
(12) Patent Application Publication
(10) Pub. No.: US 2002/0088136 A1
(43) Pub. Date: Jul. 11, 2002

(54) Electronic tape rule

(76) Inventor: Shu-Yin Tseng, Taipei (TW)

Correspondence Address: BIRCH, STEWART, KOLASCH & BIRCH, LLP, P. O. Box 747, Falls Church, VA, 22040-0747, US

(21) Appl. No.: 09/755,078

(22) Filed: Jan. 8, 2001

(51) Int. Cl. G01B 3/10; G01B 3/12; G01B 7/04

(52) U.S. Cl. 33/762; 33/755; 33/772

(57) ABSTRACT

An electronic tape rule comprising a housing, in which reside a steel tape that can be extended from the housing, a reading system that measures the extent of tape extension, and a sound play circuit that gives a read-out of the result of measurement. When the steel tape is extended from the housing, the reading system measures the extent of tape extension and passes this information to the sound play circuit to report the result of measurement for the convenience of users, especially when the measurement is operated in a dark environment.

### BACKGROUND OF THE INVENTION

### I. Field of the Invention

This invention relates generally to an electronic tape rule and, more specifically, to an electronic tape rule in which a reading system measures the extent of tape extension and a sound play circuit automatically reads out the result of the measurement. This innovative design allows users to acquire accurate readings of tape extension in circumstances where they have difficulties visually identifying the extent of tape extension, such as in the dark or having poor vision.

### II. Description of the Prior Art

Heretofore, it is known to construct a tape rule having a housing in which a steel tape can be extended from as well as retracted back to the housing. A tape rule of such construction typically has a visually readable distance scale, marked or printed on the tape. A tape rule of this kind usually requires users read the markings on the tape to obtain the information of tape extension. The scale markings on the tape are usually printed in relatively small fonts and thus are difficult for users, especially those of poor vision, to effectively complete the measurement in a dark environment. Moreover, with repeated use, the markings on the tape get unclear due to constant abrasion and thus are difficult to read, which is very likely to result in inaccurate measurement and unexpected loss. Also, this kind of tape rule cannot at all be used by the blinds.

The present invention improves on the heretofore known tape rule by installing a reading system and a sound play circuit in the housing of the tape rule. Whenever the tape is extended from the housing, the reading system measures the extent of tape extension, and the sound play circuit automatically reads out the result of measurement so that users can always obtain accurate measurements of tape extension regardless of the lighting condition.

The reading system of the present invention is composed of a wheel positioned near the opening of the housing and driven by the steel tape, a disc connected to the axle of the wheel and having a plurality of apertures along the rim, and a light sensor faced with the apertures, which measures the turning circles of the disc by detecting the movement of the apertures.

The result of the measurement is to be passed to the microprocessor on the circuit board for recording and calculating the extent of tape extension. When users press a START button, relevant auditory signals are retrieved from the voice memory, and the sound play circuit gives a read-out of the information of tape extension.

### SUMMARY OF THE INVENTION

It is therefore a primary object of the invention to provide an electronic tape rule that automatically reads out the result of the measurement of tape extension.

Another quality that the present invention is desired to simulate is to provide an electronic tape rule that can be used to obtain accurate readings of tape extension in dark places.

### BRIEF DESCRIPTION OF THE DRAWINGS

An embodiment of the invention will now be described by way of example only, with reference to the accompanying drawings, in which:

FIG. 1 is a perspective view of an electronic tape rule constructed in accordance with the present invention;

FIG. 2 is fragmentary view of the reading system of the present invention taken from the inside thereof;

FIG. 3 is a circuit block diagram of the present invention.

### DESCRIPTION OF THE PREFERRED EMBODIMENT

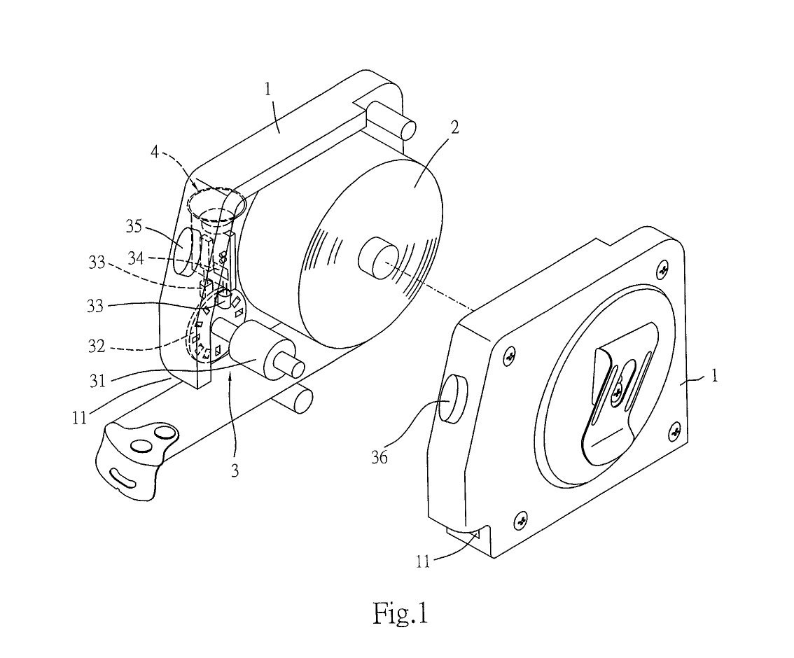

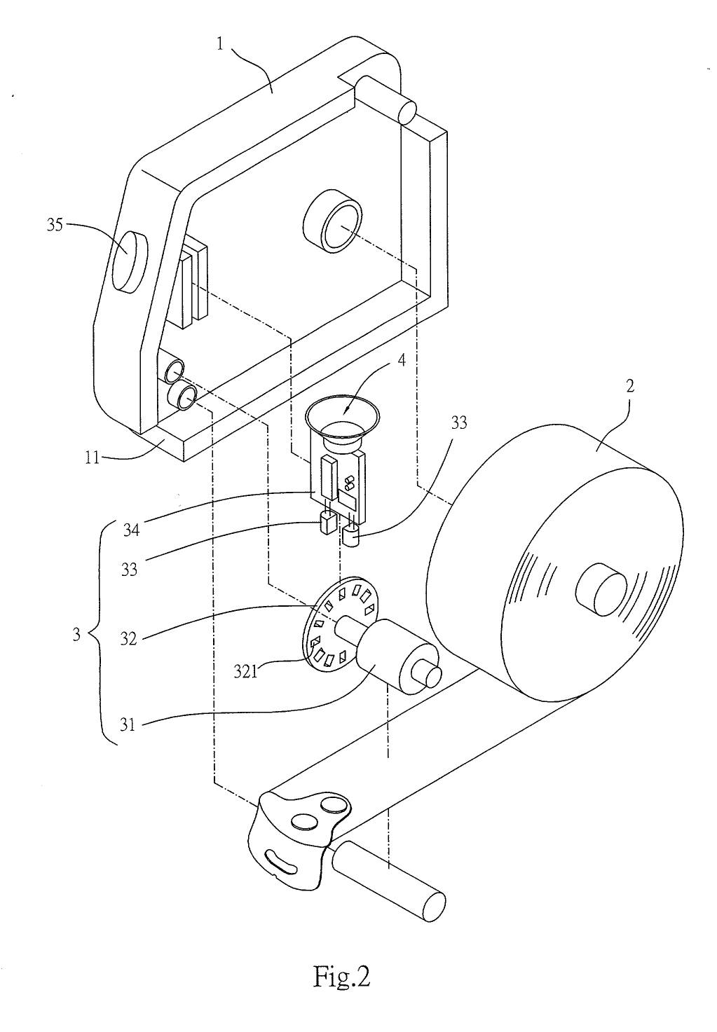

As shown in FIG. 1 and FIG. 2, the present invention is composed of a housing 1, in which reside a steel tape 2 that can be extended from and retracted back to the housing 1, a reading system 3 and an sound play circuit 4. When the steel tape 2 is extended from the housing 1, the reading system 3 measures the extent of tape extension, and the sound play circuit 4 gives a read-out of the result of measurement.

The reading system 3 comprises a wheel 31 located near the opening 11 of the housing I and driven by the steel tape 2, a disc 32 connected to the axle of the wheel 31 and having a plurality of apertures 321 along the rim, as well as a light sensor 33 faced with the apertures 321 and measuring the turning circles of the disc 32 by recording the movement of the apertures 321. The light sensor 33 passes the information on turning circles to the microprocessor on the circuit board 34 for further recording and calculating. When users press the START button 35 in order to obtain a reading, relevant voice signals are retrieved from the voice memory, and the sound play circuit 4 reads out the result indicative of the tape extension.

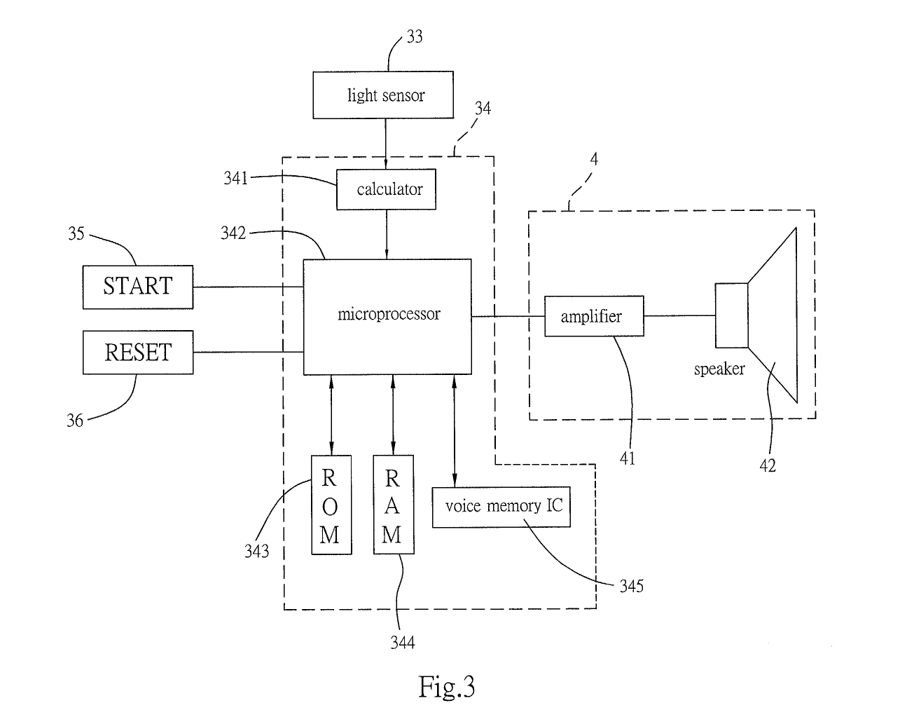

The circuit board 34 of the reading system 3, as can be seen in FIG. 3, is composed of a calculator 341, a microprocessor 342, a ROM (Read Only Memory) 343, a RAM (Random Access Memory)344 and a voice memory 345. The light sensor 33 is connected to the microprocessor 342 through the calculator 341. The microprocessor 342 is also connected to the START button 35 and the sound play circuit 4.

The turning circles of the disc 32 is detected and recorded by the light sensor 33, calculated by the calculator 341, and then processed by the microprocessor 342. The microprocessor 342 retrieves relevant information from the ROM 343 and stores it in the RAM 344. When users press the START button 35 in order to obtain a reading, the microprocessor 342 accesses the voice memory 345 for relevant auditory signals according to the information stored in the RAM 344, and then makes the sound play circuit 4 gives a read-out of the result of the measurement. The sound play circuit 4 consists of a signal amplifier 41 and a speaker 42.

As another application of the present invention, the microprocessor 342 can be linked to a RESET button 36. By pressing the RESET button 36, users are able to delete the information previously stored in the RAM 344 of the reading system 3 for re-calibration.

While only one embodiment of the present invention has been shown and described, it will be understood that various modifications and changes could be made thereunto without departing from the spirit and scope of the invention disclosed.

What is claimed is:

1. An electronic tape rule, comprising:
a housing;
a steel tape in said housing that may be extended from and retracted back to said housing;
a reading system in said housing that measures the extent of tape extension when said steel tape is extended from said housing, and
a sound play circuit that gives a read-out of the result of measurement.

2. An electronic tape rule according to claim 1, wherein the reading system is composed of a wheel positioned near the opening of said housing and driven by said steel tape, a disc connected to the axle of said wheel having a plurality of apertures along the rim, and a light sensor faced with said apertures measuring the turning circles of said disc;
wherein the information of turning circles is to be passed to the microprocessor on the circuit board for processing and when users press the START button, said microprocessor retrieves relevant auditory signals from the voice memory, making said sound play circuit read out the result of the measurement of tape extension.

3. An electronic tape rule according to claim 2, wherein said circuit board of the reading system comprises at least a calculator, a microprocessor, a ROM, a RAM, and a voice memory, with said light sensor connected to said microprocessor through said calculator, and said microprocessor also linked to the START button and said sound play circuit;
wherein the turning circles of said disc are detected by said light sensor, calculated by said calculator, and processed by said microprocessor, which retrieves relevant information from said ROM according to the process result and stores it in said RAM and when said START button is pressed, accesses said voice memory for relevant auditory signals based on information stored in said RAM and in turn makes said sound play circuit give a read-out of the result of the measurement.

4. An electronic tape rule according to claim 3, wherein said microprocessor is connected to a reset button used for re-calibration.
